(19) United States
(12) Patent Application Publication
(10) Pub. No.: US 2004/0016826 A1
(43) Pub. Date: Jan. 29, 2004

(54) Soap dispenser

(75) Inventors: Frederick John Rice, Menora (AU); Philip Frederick Rice, Menora (AU)

Correspondence Address: James R. Haller, Fredrikson & Byron, P.A., 4000 Pillsbury Center, 200 South Sixth Street, Minneapolis, MN, 55402-1425, US

(73) Assignee: SUDSMASTER

(21) Appl. No.: 10/622,349

(22) Filed: Jul. 18, 2003

Related U.S. Application Data
(63) Continuation of application No. 09/889,268, filed on Jul. 13, 2001, now abandoned.
Application No. 09/889,268 is a 371 of international application No. PCT/AU00/00015, filed on Jan. 14, 2000.

(30) Foreign Application Priority Data
Jan. 14, 1999 (AU) PP 8159

(51) Int. Cl. B05B 9/03

(52) U.S. Cl. 239/310; 239/317; 239/302

(57) ABSTRACT

A soap dispenser is disclosed which includes retaining means for supporting solid soap, the retaining means being provided with an aperture. The arrangement is such that, in use, when water is caused to flow into the retaining means, soap dissolves into the water, and the water and the dissolved soap is thereby dispensed through the aperture without physical contact between a user and the solid soap.

This invention relates to a soap dispenser.

Generally, it is known to provide soap dispensers, in the vicinity of a wash basin, bath or shower including a container of liquid soap wherein a pump action mechanism is utilised to deliver a measured dose of liquid soap through a length of tubing. It is also known to provide holders for cakes of soap in the vicinity of a wash basin, bath or shower, whereby a user may locate and use a piece of soap.

Where there is frequent use and traffic around known soap dispensers, particularly in industrial workshop areas, the very vicinity designated for users to clean themselves can become soiled. Pump action mechanism liquid soap dispensers leak liquid soap, and cakes of soap become grimy and sludgy from constant handling.

The present invention seeks, therefore, to provide a soap dispenser where there is no need to handle the cake of soap, and the user may wash under a flow of water containing dissolved soap.

In accordance with one aspect of the present invention there is provided a soap dispenser characterised in that the soap dispenser includes retaining means for supporting solid soap, the retaining means being provided with at least one aperture, the arrangement being such that, in use, when water is caused to flow into the retaining means, soap dissolves into said water, and said water and said dissolved soap is thereby dispensed through said at least one aperture without physical contact between a user and said solid soap.

The present invention will now be described, by way of example only, with reference to the accompanying drawings, in which:

FIG. 1 is a side plan view of the soap dispenser in accordance with the present invention with a cup aligned with a tap;

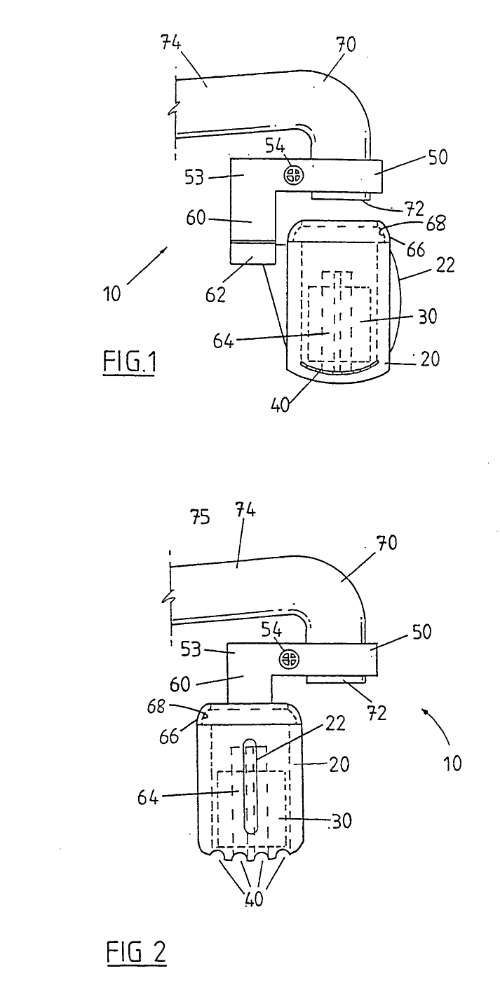

FIG. 2 is a side plan view of the soap dispenser of FIG. 1 with the cup in non-vertical alignment with the tap; and

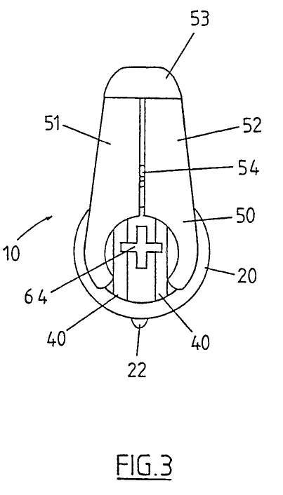

FIG. 3 is a top plan view of the soap dispenser of FIG. 1.

Referring to the Figures, in FIGS. 1 to 3 there is shown a soap dispenser 10 having retaining means for holding solid soap 30 which may be a single relatively large piece of solid soap or a plurality of relatively small pieces of solid soap. In this example, the retaining means is in the form of a cup 20. However, it will be appreciated that the retaining means could alternatively take the form of a platform, a basket or any other suitable retaining means which functions, in use, to hold a piece of soap relative to a tap. A lower portion of the cup 20 is provided with at least one aperture, in this example a plurality of apertures 40 disposed on a lower portion of the cup 20. However, it will be understood that the at least one aperture may be disposed on other portions of the cup 20, for example on a side portion of the cup 20.

The soap dispenser 10 also includes an attachment means 50 and a downwardly depending vertical shank 60 interconnecting the cup 20 and the attachment means 50, the cup 20 being pivotally mounted about a lower end 62 of the downwardly depending vertical shank 60. Also provided is a spigot 64 of cross-shaped transverse cross section, the spigot 64 extending upwardly of a lower portion of the cup 20. The spigot 64 serves to receive a generally cylindrical soap pellet and facilitates impingement of water on both an interior cylindrical surface and an exterior cylindrical surface of the soap pellet during use. In this way, during use, as the diameter of the interior cylindrical surface increases, the diameter of the exterior cylindrical surface simultaneously decreases. The spigot 64 may be provided with a generally conical cap at an end of the spigot 64 remote from the lower portion of the cup 20. The cap serves to restrict water from immediately contacting the soap pellet as the water enters the cup 20 during use. The cap also serves to restrict splashback of water from the cup 20. To further reduce the risk of splashback, the cup 20 is provided with an annular lip member 66 which may be integral with or separable from a body portion of the cup 20, the lip member 66 being provided with a curved inwardly extending surface 68 which serves to urge upwardly moving water to travel inwardly of the cup 20.

The attachment means 50 includes opposing fixed and movable jaws 51, 52 arranged in use to laterally grip opposing sides of a downwardly depending end 72 of a tap 70. The opposing fixed and movable jaws 51, 52 of the attachment means 50 may be tightened or loosened about the downwardly depending end 72 of the tap 70 by tightening or loosening, respectively, a screw 54 interconnecting the opposing fixed and movable jaws 51, 52.

It is envisaged that in alternative embodiments of the present invention, the opposing fixed and movable jaws 51, 52 of the attachment means 50 may be arranged to grip opposing sides or a shank 74 of the tap 70. It is also envisaged that the attachment means 50 could alternatively be adapted to attach to other objects such as a portion of an adjacent sink, a wall portion or a tile, the important aspect being that, in use, the attachment means 50 of the dispenser is fixed in position relative to a tap.

An end 53 of the attachment means 50 is provided with a downwardly depending vertical shank 60. The cup 20 is pivotally mounted about a lower end 62 of the downwardly depending vertical shank 60, such that in use the cup may be pivoted to a position where the cup 20 is in vertical alignment with the downwardly depending end 72 of the tap 70, as shown in FIG. 1.

The cup 20 is provided with an outwardly protruding handle 22 to aid pivotal movement of the cup 20 about the lower end 62 of the downwardly depending vertical shank 60. The cup 20 may also be provided with a projection (not shown) extending downwardly of the cup 20 below the apertures 40, the projection serving as an alternative handle for effecting pivotal movement of the cup 20. Such a projection is useful where the user has particularly dirty hands since the projection is cleaned by passing water during use.

In use, when the tap 70 is turned on, a flow of water is generated into the cup 20 and around the piece of soap 30, a portion thereof dissolving in the flow of water. The flow of water including the dissolved portion of the soap 30 flows through the apertures 40 of the cup 20, for example into an underlying receptacle, to produce “soapy” water,

When not in use, the cup 20 may be pivoted about the lower end 62 of the downwardly depending vertical shank 60 to a position where the cup is not in vertical alignment with the downwardly depending end 72 of the tap 70, as shown in FIG. 2. The tap 70 may be turned on to generate a flow of water, for example into an underlying receptacle, without producing “soapy” water.

It will be appreciated that instead of providing a cup which is adapted to pivot relative to a vertical shank, the cup could be fixed relative to the vertical shank and a pivotable tap provided such that the outlet of the tap is moveable into and out of alignment with the cup.

It will also be appreciated that instead of providing retaining means which is pivotable about a substantially vertical axis, the soap dispenser could be arranged so that the retaining means is pivotable about other axes, the important aspect being that the retaining means is pivotable from a location wherein water flows through the retaining means to a position wherein water does not flow through the retaining means.

Furthermore, it will be appreciated that as an alternative to the cup of the above described specific embodiment, a retaining means having a plurality of compartments could be provided. With such an alternative embodiment, the retaining means would be rotatable such that each compartment is selectively alignable with a tap outlet. One of the compartments could be a hollow cylinder through which water may pass unhindered, and the other two compartments could contain soap, each respective soap being for a particular use.

Modifications and variations as would be apparent to a skilled addressee are deemed to be within the scope of the present invention.

1. A soap dispenser characterised in that the soap dispenser includes retaining means for supporting solid soap, the retaining means being provided with at least one aperture, the arrangement being such that, in use, when water is caused to flow into the retaining means, soap dissolves into said water, and said water and said dissolved soap is thereby dispensed through said at least one aperture without physical contact between a user and said solid soap.

2. A soap dispenser as claimed in claim 1, characterised in that the retaining means is movable into and out of alignment with an outlet of a tap.

3. A soap dispenser as claimed in claim 2, characterised in that the retaining means is pivotable about a substantially vertical axis.

4. A soap dispenser as claimed in claim 2 or claim 3, characterised in that the soap dispenser further includes a projection extending outwardly of said at least one aperture, the projection serving as a handle to facilitate movement of the retaining means and the projection being cleaned by water passing through the at least one aperture during use.

5. A soap dispenser as claimed in any one of claims 1 to 4, characterised in that the retaining means is substantially cup-shaped.

6. A soap dispenser as claimed in any one of claims 1 to 4, characterised in that the retaining means is a platform or a basket.

7. A soap dispenser as claimed in any one of claims 1 to 6, characterised in that the soap dispenser further includes a spigot extending from the retaining means.

8. A soap dispenser as claimed in claim 7, characterised in that said solid soap is a substantially cylindrical soap portion adapted to engage with the spigot.

9. A soap dispenser as claimed in claim 7 or claim 8, characterised in that the transverse cross section of the spigot is substantially cross-shaped.

10. A soap dispenser as claimed in any one of the preceding claims, characterised in that the soap dispenser further includes attachment means for attaching the soap dispenser to an object such that the retaining means locates a predetermined distance from a tap.

11. A soap dispenser as claimed in claim 10, characterised in that the attachment means is adapted to engage with a tap, a sink portion or a wall portion.

12. A soap dispenser as claimed in claim 10 or claim 11, characterised in that the attachment means includes a plurality of jaws and means for adjusting the spaced relationship of the jaws.

13. A soap dispenser as claimed in any one of the preceding claims, further including means for restricting water from immediately contacting said solid soap as water enters the retaining means during use.

14. A soap dispenser as claimed in claim 13, characterised in that the said restricting means is a substantially conical shaped cap.

15. A soap dispenser as claimed in any one of the preceding claims, further including means for urging upwardly moving water to move inwardly of the retaining means so as to thereby restrict splashback of water during use.

16. A soap dispenser as claimed in claim 15, characterised in that said urging means is a substantially annular lip member having an inwardly extending inner surface.

17. A soap dispenser as claimed in any one of the preceding claims, characterised in that the retaining means includes a plurality of compartments, each compartment of which is adapted to receive solid soap.

18. A soap dispenser as claimed in any one of the preceding claims, characterised in that the retaining means is provided with a plurality of apertures.

19. A soap dispenser characterised in that the soap dispenser includes retaining means for supporting solid soap, the retaining means being provided with an inlet aperture and at least one outlet aperture and the retaining means being arranged to retain said solid soap between the inlet aperture and the at least one outlet aperture.

20. A soap pellet for use in a soap dispenser as claimed in any one of the preceding claims, characterised in that the soap pellet is substantially cylindrical in shape.
